(19) United States
(12) Patent Application Publication
(10) Pub. No.: US 2025/0192314 A1
(43) Pub. Date: Jun. 12, 2025

(54) TRACTION BATTERY PACK WITH ENCLOSURE ENDCAP

(71) Applicant: Ford Global Technologies, LLC, Dearborn, MI (US)

(72) Inventors: Derek Timothy Taylor, Waterford, MI (US); John Peter Bilezikjian, Canton, MI (US); Nicholas Braeseker, Novi, MI (US)

(21) Appl. No.: 18/760,633

(22) Filed: Jul. 1, 2024

Related U.S. Application Data
(60) Provisional application No. 63/607,888, filed on Dec. 8, 2023.

(51) Int. Cl. H01M 50/258; H01M 50/249; H01M 50/262; H01M 50/276; H01M 50/627

(52) U.S. Cl. CPC H01M 50/258; H01M 50/249; H01M 50/262; H01M 50/276; H01M 50/627

(57) ABSTRACT

A traction battery pack assembly, includes an enclosure lid providing a channel; an enclosure endcap assembly that covers an end of the channel; and at least one cell stack within the channel. The at least one cell stack has one or more battery cells. The assembly can include a planar enclosure bottom. The enclosure lid can be folded.

### CROSS-REFERENCE TO RELATED APPLICATIONS

This disclosure claims priority to U.S. Provisional Application No. 63/607,888, which was filed on Dec. 8, 2023, and is incorporated herein by reference in its entirety.

### TECHNICAL FIELD

This disclosure details exemplary traction battery pack enclosures and, more particularly, to an enclosure having at least one removeable endcap assembly.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. The traction battery pack assembly can include at least one cell stack held within an enclosure assembly.

### SUMMARY

In some aspects, the techniques described herein relate to a traction battery pack assembly, including: an enclosure lid providing a channel; an enclosure endcap assembly that covers an end of the channel; and at least one cell stack within the channel, the at least one cell stack having one or more battery cells.

In some aspects, the techniques described herein relate to a traction battery pack assembly, further including an enclosure bottom, the at least one cell stack disposed on the enclosure bottom.

In some aspects, the techniques described herein relate to a traction battery pack assembly, wherein the enclosure bottom is a skid plate.

In some aspects, the techniques described herein relate to a traction battery pack assembly, wherein the enclosure bottom is planar.

In some aspects, the techniques described herein relate to a traction battery pack assembly, wherein the enclosure lid includes a first section folded along an axis relative to a second section.

In some aspects, the techniques described herein relate to a traction battery pack assembly, wherein the enclosure lid is adhesively secured to the enclosure bottom.

In some aspects, the techniques described herein relate to a traction battery pack assembly, wherein the enclosure endcap assembly is a first enclosure endcap assembly that covers a first end of the channel, and further including a second enclosure endcap assembly that covers an opposite, second end of the channel.

In some aspects, the techniques described herein relate to a traction battery pack assembly, further including an attachment bracket at least partially disposed within the channel, the enclosure endcap assembly secured directly to the enclosure endcap assembly.

In some aspects, the techniques described herein relate to a traction battery pack assembly, wherein the attachment bracket is annular.

In some aspects, the techniques described herein relate to a traction battery pack assembly, wherein the enclosure endcap assembly is removeable.

In some aspects, the techniques described herein relate to a traction battery pack assembly, wherein the enclosure endcap assembly is secured using a plurality of mechanical fasteners.

In some aspects, the techniques described herein relate to a traction battery pack assembly, wherein the enclosure endcap assembly includes at least one connection interface for operably coupling a component within the channel to a component outside the channel.

In some aspects, the techniques described herein relate to a traction battery pack assembly, wherein the at least one connection interface includes at least one electrical connection interface.

In some aspects, the techniques described herein relate to a traction battery pack assembly, wherein the at least one connection interface includes a coolant port.

In some aspects, the techniques described herein relate to a traction battery pack enclosure assembly, including: an enclosure lid having a top wall and a pair of sidewalls, the pair of sidewalls extend away from opposing sides of the top wall to provide a channel; an enclosure bottom secured to the pair of sidewalls opposite the enclosure lid; a first enclosure endcap assembly that covers a first end of the channel; a second enclosure endcap assembly that covers an opposite, second end of the channel; and at least one cell stack within the channel, the at least one cell stack having one or more battery cells.

In some aspects, the techniques described herein relate to a traction battery pack enclosure assembly, further including a first attachment bracket at least partially within the channel and a second attachment bracket at least partially within the channel, the first enclosure endcap assembly secured directly to the first attachment bracket, the second enclosure endcap assembly secured directly to the second attachment bracket.

In some aspects, the techniques described herein relate to a traction battery pack enclosure assembly, wherein a plurality of mechanical fasteners secure the first enclosure endcap assembly directly to the enclosure lid.

In some aspects, the techniques described herein relate to a traction battery pack enclosure assembly, wherein the first enclosure endcap assembly includes at least one connection interface for operably coupling a component within the channel to a component outside the channel.

In some aspects, the techniques described herein relate to a traction battery pack enclosure assembly, wherein the at least one connection interface includes at least one electrical connection interface.

In some aspects, the techniques described herein relate to a traction battery pack enclosure assembly, wherein the at least one connection interface includes a coolant port.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a perspective, schematic view of the battery pack of FIG. 1 having an enclosure assembly with a folded enclosure piece.

FIG. 3 illustrates an expanded view of the battery pack of FIG. 2.

FIGS. 4-7 illustrate perspective views of a sheet of material being folded into the folded enclosure piece.

FIG. 8 illustrates a perspective view of an enclosure assembly according to another exemplary aspect of the present disclosure.

### DETAILED DESCRIPTION

A battery pack can include at least one cell stack and other components housed within an enclosure assembly. To provide the enclosure assembly, multiple enclosure pieces can be joined together. From time to time, servicing components can be required. This disclosure is directed toward enclosure endcap assemblies that can be removed to provide access to components within an interior of a battery pack.

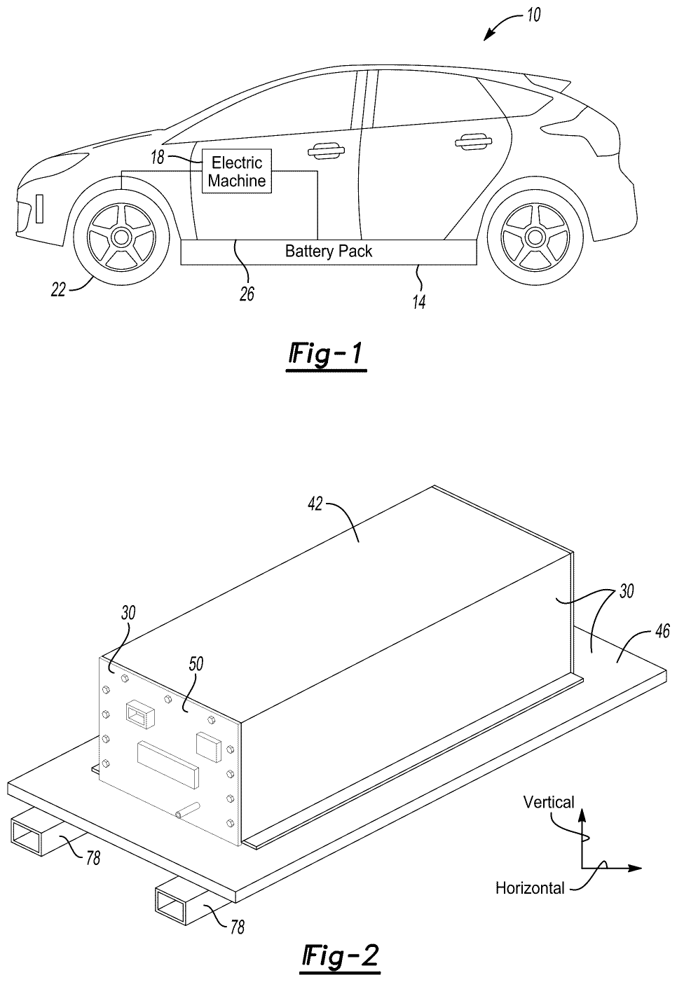

With reference to FIG. 1, an electrified vehicle 10 includes a traction battery pack 14, an electric machine 18, and wheels 22. The traction battery pack 14 powers the electric machine 18, which can convert electrical power to mechanical power to drive the wheels 22.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

The traction battery pack 14 is, in the exemplary embodiment, secured to an underbody 26 of the electrified vehicle 10. The traction battery pack 14 could be located elsewhere on the electrified vehicle 10 in other examples.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

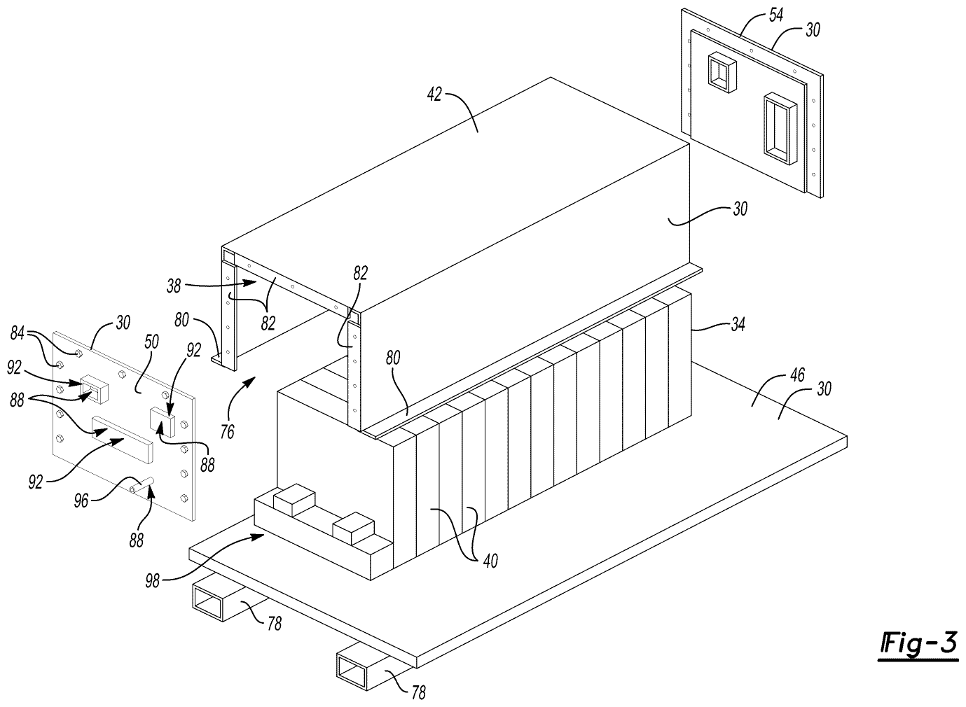

Referring now to FIGS. 2 and 3, the battery pack 14 includes an enclosure assembly 30 and at least one cell stack 34. The example enclosure assembly 30 includes a plurality of enclosure pieces that cooperate to enclose the at least one cell stack 34 within an interior 38 of the enclosure assembly 30.

In this disclosure, the at least one cell stack 34 having one or more individual battery cells 40 disposed along a cell stack axis A. The cell stack 34 could include any number of battery cells 40. Further, the battery pack 14 could employ any number of cell stacks 34 within the enclosure assembly 30. Thus, this disclosure is not limited to the exact configuration shown.

In an embodiment, the battery cells 40 are pouch-style, lithium-ion cells. However, battery cells having other geometries (cylindrical, prismatic, etc.), other chemistries (nickel-metal hydride, lead-acid, etc.), or both could alternatively be utilized within the scope of this disclosure.

In the exemplary embodiment, the enclosure assembly 30 includes an enclosure lid 42, an enclosure bottom 46, a first enclosure endcap assembly 50, and a second enclosure endcap assembly 54. The enclosure lid 42 is disposed vertically above the enclosure bottom 46 in this example. Vertical, for purposes of this disclosure, is with reference to ground and a general orientation of the vehicle 10 and the battery pack 14 during operation.

Various terms such as “above,” “below,” “top,” and “bottom” are used relative to the arrangement of the components of the battery pack 14 in the various drawings and should not otherwise be deemed limiting. These terms are with reference to the general orientation of the battery pack 14 when installed within the vehicle 10 of FIG. 1.

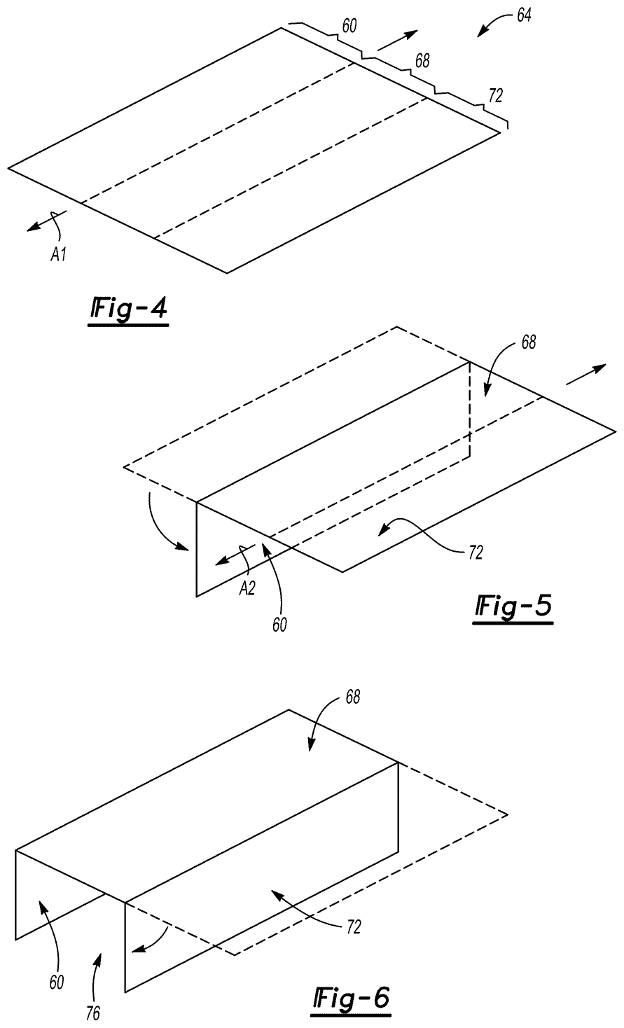

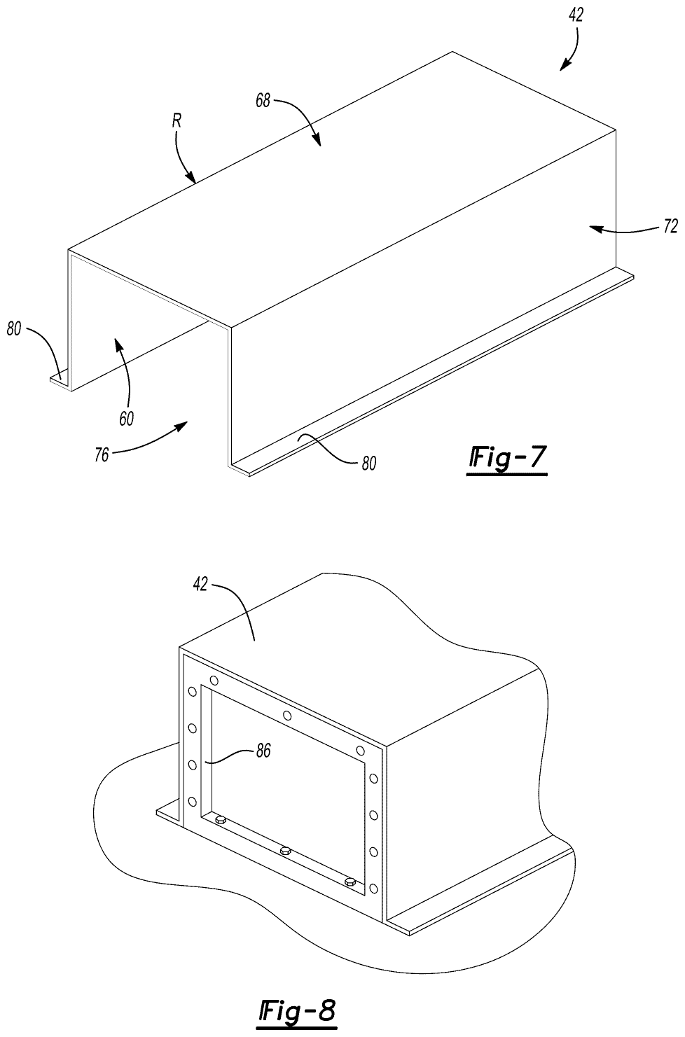

With reference now to FIGS. 4 to 7 and continuing reference to FIGS. 2 and 3, the example enclosure lid 42 is provided by bending a first section 60 of a sheet of material 64 relative to a second section 68 of the sheet of material 64. The bending of the first section 60 is a bending about a first axis A1. Tooling, such as stamping machines, can be used to fold the first section 60 relative to the second section 68. A person having skill in this art and the benefit of this disclosure could understand how to use tooling to bend a sheet of material.

The sheet of material 64 that is folded to provide the example enclosure lid 42 is a metal or metal alloy, such as sheet metal. The sheet of material 64 is planar.

A person having skill in this art would understand how to structurally distinguish a folded component from a component that is not folded. Thus, specifying that the enclosure lid 42 is a folded enclosure lid implicates structure to the enclosure lid 42 and structurally distinguishes the enclosure lid 42 from an enclosure lid that is not folded, such as a deep-drawn enclosure lid, or a cast enclosure lid.

While the enclosure lid 42 is a folded enclosure lid in this example, the enclosure lid could be a deep drawn enclosure lid, a cast enclosure lid, or another type of lid in other examples.

In the exemplary embodiment, a third section 72 of the sheet of material 64 is bent relative to the second section 68 about a second axis A2. The third section 72 and the first section 60 then extend parallel to each other from opposing sides of the second section 68 to provide a channel 76. End portions of the first section 60 and the third section 72 can then be bent to provide lips 80.

The first axis A1 and the second axis A2 are parallel to each other in this example. The first section 60 and the third section 72 are disposed are also parallel to each other, and are perpendicular to the second section 68.

The example enclosure lid 42 is U-shaped. When assembled, the second section 68 provides a top wall for the enclosure assembly 30, and the first section 60 and the second section 68 provide a pair of sidewalls for the enclosure assembly 30. The first section 60 and the second section 68 extend downward away from opposite sides of the top wall provided by the second section 68.

Due to the folding to provide the U-shape, a radius R between the first section 60 and the second section 68 is smaller than the radius that would be required to form a deep-drawn channel that is deep drawn. Similarly, a radius between the second section 68 and the third section 72 is smaller than the radius that would be required to form a deep-drawn channel.

The enclosure bottom 46 is a skid plate in this example. The enclosure bottom 46 is planar and is not folded. The enclosure bottom 46, in this example, provides no recessed area that receives the cell stack 34. In other examples, the enclosure bottom 46 is an enclosure tray providing a recessed area that receives at least a portion of the cell stack 34.

The enclosure lid 42 can be placed over the cell stack 34, which positions the cell stack 34 within the channel 76. The enclosure lid 42, particularly the second section 68 can be adhesively secured to a top side of the cell stack 34 to, among other things, help stiffen the battery pack 14.

The enclosure lid 42, the enclosure bottom 46, the first enclosure endcap assembly 50, and the second enclosure endcap assembly 54 cooperate to enclose the cell stack 34. In this example, the cell stack 34 is disposed upon a planar top surface of the enclosure bottom 46 with the enclosure bottom 46 is directly supporting the cell stack 34. The enclosure bottom 46 can be secured to structural members of the vehicle 10, such as side rails 78 of the vehicle 10.

The enclosure lid 42 is attached to the enclosure bottom 46 through the lips 80. Mechanical fasteners, adhesive, or both can be used to secure the enclosure lid 42 to the enclosure bottom 46. If desired, seals can be incorporated between the lips 80 and the enclosure bottom 46 to seal interfaces between the lips 80 and the enclosure bottom 46.

The first enclosure endcap assembly 50 and the second enclosure endcap assembly 54 can be installed to opposite ends of the channel 76 to enclosure the cell stack 34 within the interior 38. The first enclosure endcap assembly 50 covers a first end of the channel 76. The second enclosure endcap assembly 54 covers an opposite, second end of the channel.

The first enclosure endcap assembly 50 and the second enclosure endcap assembly 54 can each be secured to flanges 82 of the enclosure lid 42. The first enclosure endcap assembly 50 and the second enclosure endcap assembly 54 could be secured to the flanges 82 using mechanical fasteners 84 (e.g., clips, bolts). The first enclosure endcap assembly 50 and the second enclosure endcap assembly 54 can include portions that are stamped, cast, composite, etc.

Interfaces between the first enclosure endcap assembly 50 and the other components can be sealed, as can interfaces between the second enclosure endcap assembly 54 and the other components. The seal can be a foam seal in some examples. Accessing the components within the interior 38 for service can be accomplished by removing the first enclosure endcap assembly 50 or the second enclosure endcap assembly 54.

In another example, as shown in FIG. 8, the first enclosure endcap assembly 50 and the second enclosure endcap assembly 54 could each instead or additionally be secured to a respective attachment bracket 86 that is separate from the enclosure lid 42. The bracket 86 could be pre-installed to either the folded enclosure piece 68 or to plate 46. The mechanical fasteners 84 can be used to secure the first enclosure endcap assembly 50 and the second enclosure endcap assembly 54 to the respective attachment bracket 86.

Each attachment bracket 86 can be a hoop-shaped, annular bracket. Each attachment bracket 86 can be entirely within the channel 76 or can protrude slightly from the channel 76, such that the attachment bracket 86 is only partially within the channel 76. The attachment brackets 86 can be a polymer-based material, a metal, or a metal allow. The attachment brackets 86 can help to maintain the U-shape of the enclosure lid 42.

Referring again to FIGS. 2-7, the first enclosure endcap assembly 50, the second enclosure endcap assembly 54, or both include various connection interfaces 88, such as electrical connection interfaces 92 and coolant ports 96. The connection interfaces 88 provide interfaces for coupling components within the enclosure assembly 30 of the battery pack 14 to other portions of the vehicle 10. A component within the channel 76 can be connected to a component outside the channel 76 (and outside the battery pack 14) through the electrical connection interfaces 92. Coolant, for example, can be circulated into the interior 38 through the coolant port 96 in the first enclosure endcap assembly 50. The electrical connection interfaces 92 can be plug-in interfaces.

Providing the connection interfaces 88 within the first enclosure endcap assembly 50 and the second enclosure endcap assembly 54 can facilitate servicing the battery pack 14. As an example, a technician needing to service components within the channel 76 can disconnect the various connection interfaces 88 and then remove the first enclosure endcap assembly 50, the second enclosure endcap assembly 54, or both after disengaging the mechanical fasteners 84. The technician can then access areas within the channel 76 without disassembling the enclosure lid 42 from the enclosure bottom 46.

In some examples, the battery pack 14 can include electrical components 98, such as a Battery Energy Control Module (BECM), Bussed Electrical Center (BEC), DC/DC converter, etc., within a power electronics area that is directly behind the first enclosure endcap assembly 50. The technician can directly access these components after removing the first enclosure endcap assembly 50. In some examples, portions of these components can be mounted to the first enclosure endcap assembly.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
an enclosure lid providing a channel;
an enclosure endcap assembly that covers an end of the channel; and
at least one cell stack within the channel, the at least one cell stack having one or more battery cells.

2. The traction battery pack assembly of claim 1, further comprising an enclosure bottom, the at least one cell stack disposed on the enclosure bottom.

3. The traction battery pack assembly of claim 2, wherein the enclosure bottom is a skid plate.

4. The traction battery pack assembly of claim 2, wherein the enclosure bottom is planar.

5. The traction battery pack assembly of claim 2, wherein the enclosure lid includes a first section folded along an axis relative to a second section.

6. The traction battery pack assembly of claim 5, wherein the enclosure lid is adhesively secured to the enclosure bottom.

7. The traction battery pack assembly of claim 1, wherein the enclosure endcap assembly is a first enclosure endcap assembly that covers a first end of the channel, and further comprising a second enclosure endcap assembly that covers an opposite, second end of the channel.

8. The traction battery pack assembly of claim 1, further comprising an attachment bracket at least partially disposed within the channel, the enclosure endcap assembly secured directly to the enclosure endcap assembly.

9. The traction battery pack assembly of claim 8, wherein the attachment bracket is annular.

10. The traction battery pack assembly of claim 1, wherein the enclosure endcap assembly is removeable.

11. The traction battery pack assembly of claim 1, wherein the enclosure endcap assembly is secured using a plurality of mechanical fasteners.

12. The traction battery pack assembly of claim 1, wherein the enclosure endcap assembly includes at least one connection interface for operably coupling a component within the channel to a component outside the channel.

13. The traction battery pack assembly of claim 12, wherein the at least one connection interface comprises at least one electrical connection interface.

14. The traction battery pack assembly of claim 12, wherein the at least one connection interface comprises a coolant port.

15. A traction battery pack enclosure assembly, comprising:
an enclosure lid having a top wall and a pair of sidewalls, the pair of sidewalls extend away from opposing sides of the top wall to provide a channel;
an enclosure bottom secured to the pair of sidewalls opposite the enclosure lid;
a first enclosure endcap assembly that covers a first end of the channel;
a second enclosure endcap assembly that covers an opposite, second end of the channel; and
at least one cell stack within the channel, the at least one cell stack having one or more battery cells.

16. The traction battery pack enclosure assembly of claim 15, further including a first attachment bracket at least partially within the channel and a second attachment bracket at least partially within the channel, the first enclosure endcap assembly secured directly to the first attachment bracket, the second enclosure endcap assembly secured directly to the second attachment bracket.

17. The traction battery pack enclosure assembly of claim 15, wherein a plurality of mechanical fasteners secure the first enclosure endcap assembly directly to the enclosure lid.

18. The traction battery pack enclosure assembly of claim 15, wherein the first enclosure endcap assembly includes at least one connection interface for operably coupling a component within the channel to a component outside the channel.

19. The traction battery pack enclosure assembly of claim 18, wherein the at least one connection interface comprises at least one electrical connection interface.

20. The traction battery pack enclosure assembly of claim 18, wherein the at least one connection interface comprises a coolant port.
